(19) United States
(12) Patent Application Publication
(10) Pub. No.: US 2026/0017931 A1
(43) Pub. Date: Jan. 15, 2026

(54) MACHINE LEARNING DEVICE, MACHINE LEARNING METHOD, AND COMPUTER-READABLE MEDIUM STORING MACHINE LEARNING PROGRAM

(71) Applicant: MITSUBISHI ELECTRIC CORPORATION, Tokyo (JP)

(72) Inventors: Kazuhiro KAMADA, Tokyo (JP); Naohiro SHIBUYA, Tokyo (JP); Akira MINEZAWA, Tokyo (JP)

(73) Assignee: MITSUBISHI ELECTRIC CORPORATION, Tokyo (JP)

(21) Appl. No.: 19/330,682

(22) Filed: Sep. 16, 2025

Related U.S. Application Data
(63) Continuation of application No. PCT/JP2023/018511, filed on May 18, 2023.

(51) Int. Cl. G06V 10/774; G06V 10/72; G06V 10/74; G06V 10/77; G06V 10/776

(52) U.S. Cl. CPC G06V 10/774; G06V 10/72; G06V 10/74; G06V 10/7715; G06V 10/776

(57) ABSTRACT

A machine learning device includes an image set acquiring unit to acquire an image set including images, and an image set selecting unit to select an image set similar to the acquired image set from a plurality of image sets different from the acquired image set. In addition, the machine learning device includes a performance comparison unit, and a preprocessing acquisition unit to select a learning model from a plurality of machine-learned learning models based on a performance comparison result by the performance comparison unit and to acquire preprocessing performed on an image set used for machine learning of the learning model selected. Furthermore, the machine learning device includes a model learning unit to perform the acquired preprocessing on the acquired image set and to cause a learning model that has not yet trained to perform machine learning using the preprocessed image set.

### CROSS REFERENCE TO RELATED APPLICATION

This application is a Continuation of PCT International Application No. PCT/JP2023/018511, filed on May 18, 2023, which is hereby expressly incorporated by reference into the present application.

### TECHNICAL FIELD

The present disclosure relates to a machine learning device, a machine learning method, and a computer-readable medium storing machine learning program.

### BACKGROUND ART

There is a machine learning device that causes a learning model to perform machine learning using a plurality of pieces of data.

As such a machine learning device, for example, Patent Literature 1 discloses a machine learning device including a learning unit.

The learning unit causes a learning model to perform machine learning using an image set including a plurality of images.

### CITATION LIST

### Patent Literatures

Patent Literature 1: JP 2023-30540 A

### SUMMARY OF INVENTION

### Technical Problem

An image included in an image set used for machine learning of a learning model may include, for example, a missing value or an outlier.

In the machine learning device disclosed in Patent Literature 1, since the missing value or the like is included in the image included in the image set used for machine learning, there is a problem that the performance of the learning model after machine learning by the learning unit may decrease.

The present disclosure has been made to solve the above problems, and an object of the present disclosure is to obtain a machine learning device capable of suppressing a decrease in performance of a learning model after machine learning even when one or more images included in an image set include a missing value or the like.

### Solution to Problem

A machine learning device according to the present disclosure includes processing circuitry to acquire an image set including one or more images, and to select an image set similar to the acquired image set from a plurality of image sets different from the acquired image set. In addition, the processing circuitry is configured to acquire, as performances of a plurality of machine-learned learning models, a performance of a learning model that has performed machine learning using each of preprocessed image sets obtained by performing a plurality of pieces of different preprocessing on the selected image set, and to compare the performances of the plurality of machine-learned learning models with each other, and to select a learning model from the plurality of machine-learned learning models based on a performance comparison result and to acquire preprocessing performed on an image set used for machine learning of the learning model selected. Furthermore, the processing circuitry is configured to perform the acquired preprocessing on the acquired image set and to cause a learning model that has not yet trained to perform machine learning using the preprocessed image set.

### Advantageous Effects of Invention

According to the present disclosure, even when one or more images included in the image set include a missing value or the like, it is possible to suppress a decrease in performance of the learning model after machine learning.

### BRIEF DESCRIPTION OF DRAWINGS

FIG. 1 is a configuration diagram illustrating a machine learning device according to a first embodiment.

FIG. 2 is a hardware configuration diagram illustrating hardware of the machine learning device according to the first embodiment.

FIG. 3 is a hardware configuration diagram of a computer in a case where the machine learning device is implemented by software, firmware, or the like.

FIG. 4 is a flowchart illustrating a machine learning method that is a processing procedure performed by the machine learning device.

FIG. 5 is a configuration diagram illustrating a machine learning device according to a second embodiment.

FIG. 6 is a hardware configuration diagram illustrating hardware of the machine learning device according to the second embodiment.

FIG. 7 is an explanatory diagram illustrating an example of a second learning model to which an image set GS″ after data dimension reduction is provided.

### DESCRIPTION OF EMBODIMENTS

Hereinafter, in order to describe the present disclosure in more detail, modes for carrying out the present disclosure will be described with reference to the accompanying drawings.

### First Embodiment

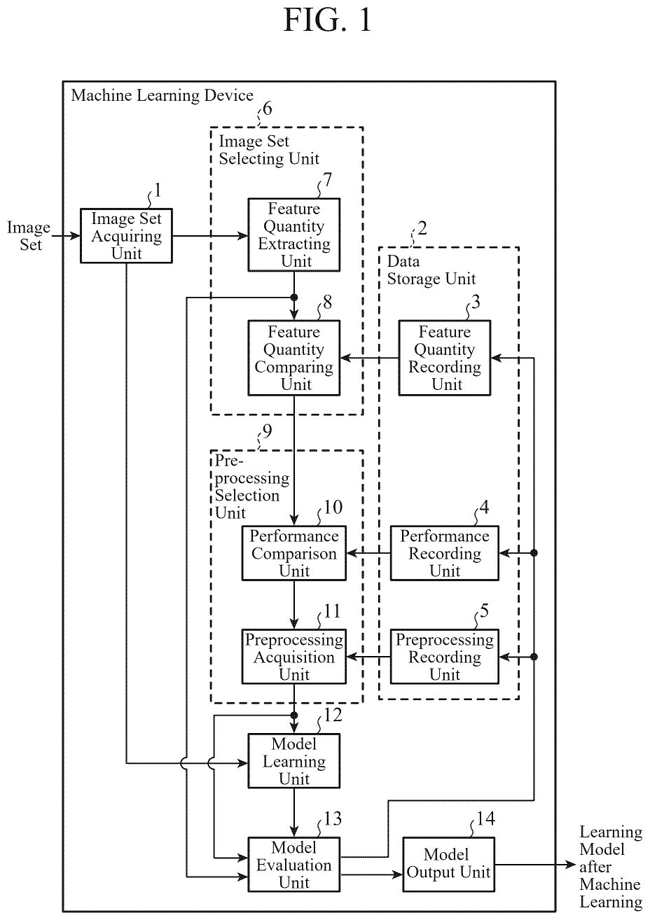

FIG. 1 is a configuration diagram illustrating a machine learning device according to a first embodiment.

FIG. 1 is a hardware configuration diagram illustrating hardware of the machine learning device according to the first embodiment.

The machine learning device illustrated in FIG. 1 includes an image set acquiring unit 1, a data storage unit 2, an image set selecting unit 6, a preprocessing selection unit 9, a model learning unit 12, a model evaluation unit 13, and a model output unit 14.

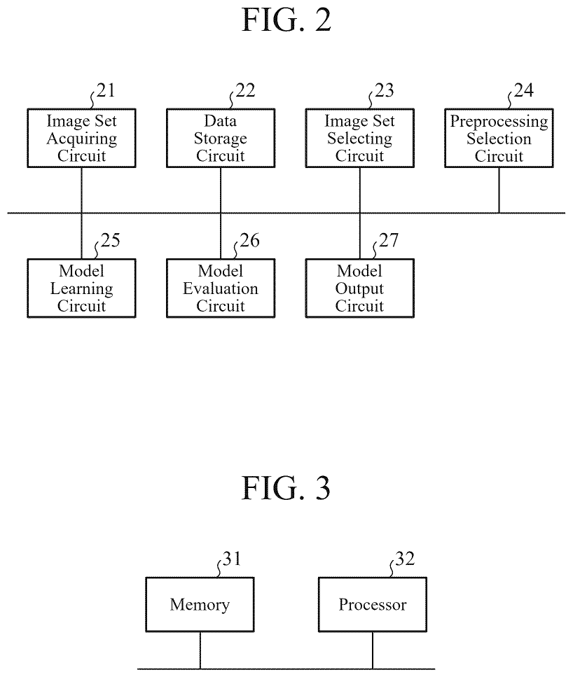

The image set acquiring unit 1 is implemented by, for example, an image set acquiring circuit 21 illustrated in FIG. 2.

The image set acquiring unit 1 acquires an image set GS including one or more images from the outside.

The image set acquiring unit 1 outputs the image set GS to each of the image set selecting unit 6 and the model learning unit 12.

The data storage unit 2 is implemented by, for example, a data storage circuit 22 illustrated in FIG. 2.

The data storage unit 2 includes a feature quantity recording unit 3, a performance recording unit 4, and a preprocessing recording unit 5.

The feature quantity recording unit 3 records feature quantities Fv₁ to Fv_{N} respectively extracted from N image sets GS₁ to GS_{N} different from the image set acquired by the image set acquiring unit 1. Nis an integer equal to or larger than one.

The performance recording unit 4 records performances S_{1,1} to S_{N,M} of N×M learning models MDL_{1,1} to MDL_{N,M} that has performed machine learning using each of N×M image sets GS_{1,1} to GS_{N,M} in which any different preprocessing Pₘ (m=1, . . . , M) among M pieces of preprocessing P₁ to P_{M} has been performed. Mis an integer equal to or larger than two.

The preprocessing recording unit 5 records M pieces of preprocessing P₁ to P_{M}.

The image set selecting unit 6 is implemented by, for example, an image set selecting circuit 23 illustrated in FIG. 2.

The image set selecting unit 6 includes a feature quantity extracting unit 7 and a feature quantity comparing unit 8.

The image set selecting unit 6 acquires the image set GS from the image set acquiring unit 1.

The image set selecting unit 6 selects an image set GS_{SEL} similar to the image set GS from the N image sets GS₁ to GS_{N}.

The image set selecting unit 6 outputs the selected image set GS_{SEL} to the preprocessing selection unit 9.

The feature quantity extracting unit 7 acquires the image set GS from the image set acquiring unit 1.

The feature quantity extracting unit 7 extracts a feature quantity Fv of the image set GS, and outputs the feature quantity Fv to each of the feature quantity comparing unit 8 and the model evaluation unit 13.

The feature quantity comparing unit 8 acquires the feature quantity Fv of the image set GS from the feature quantity extracting unit 7.

The feature quantity comparing unit 8 compares the feature quantity Fv of the image set GS with the feature quantities Fv₁ to FUN respectively extracted from the N image sets GS₁ to GS_{N} recorded in the feature quantity recording unit 3.

The feature quantity comparing unit 8 selects an image set GS_{SEL} similar to the image set GS acquired by the image set acquiring unit 1 from the N image sets GS₁ to GS_{N} on the basis of the comparison result between the feature quantity Fv of the image set GS and the N feature quantities Fv₁ to Fv_{N}.

The feature quantity comparing unit 8 outputs the selected image set GS_{SEL} to the performance comparison unit 10.

The preprocessing selection unit 9 is implemented by, for example, a preprocessing selection circuit 24 illustrated in FIG. 2.

The preprocessing selection unit 9 includes a performance comparison unit 10 and a preprocessing acquisition unit 11.

The preprocessing selection unit 9 acquires preprocessing P_{SEL} suitable for the image set GS acquired by the image set acquiring unit 1 from the M pieces of preprocessing P₁ to P_{M} recorded in the preprocessing recording unit 5.

The preprocessing selection unit 9 outputs the preprocessing P_{SEL} to the model learning unit 12.

The performance comparison unit 10 acquires the image set GS_{SEL} selected by the image set selecting unit 6.

The performance comparison unit 10 acquires, from the performance recording unit 4, performance S_{SEL,m} of a learning model MDL_{SEL,m} that has performed machine learning using each of preprocessed image set GS_{SEL,m} (m=1, . . . , M) obtained by performing M different pieces of preprocessing P₁ to P_{M} on the image set GS_{SEL} selected by the image set selecting unit 6, as the performances S_{SEL,1} to S_{SEL,M} of the M machine-learned learning models MDL_{SEL,1} to MDL_{SEL,M}.

The performance comparison unit 10 compares the M performance S_{SEL,1} to S_{SEL,M} with each other, and outputs the performance comparison result to the preprocessing acquisition unit 11.

The preprocessing acquisition unit 11 acquires the performance comparison result from the performance comparison unit 10.

The preprocessing acquisition unit 11 selects a learning model MDL_{SEL} from the M learning models MDL_{SEL,1} to MDL_{SEL,M} on the basis of the performance comparison result by the performance comparison unit 10.

The preprocessing acquisition unit 11 acquires, as the preprocessing P_{SEL}, preprocessing Pₘ performed on the image set GS_{SEL,m} used for machine learning of the learning model MDL_{SEL} from the M pieces of preprocessing P₁ to P_{M} recorded in the preprocessing recording unit 5.

The preprocessing acquisition unit 11 outputs the acquired preprocessing P_{SEL} to each of the model learning unit 12 and the model evaluation unit 13.

The model learning unit 12 is implemented by, for example, a model learning circuit 25 illustrated in FIG. 2.

The model learning unit 12 acquires the image set GS from the image set acquiring unit 1, and acquires the preprocessing P_{SEL} from the preprocessing acquisition unit 11.

The model learning unit 12 performs the preprocessing P_{SEL} on the image set GS, and causes the learning model MDL that has not yet trained to perform machine learning using a preprocessed image set GS′.

The model learning unit 12 outputs a learning model MDL′ after machine learning to the model evaluation unit 13.

In a case where a plurality of pieces of preprocessing P_{SEL} are selected by the preprocessing selection unit 9, the model learning unit 12 performs each of the pieces of preprocessing P_{SEL} on the image set GS, and causes the learning model MDL that has not yet trained to perform machine learning using each preprocessed image set GS′.

The model learning unit 12 outputs a plurality of learning models MDL′ after machine learning to the model evaluation unit 13.

The model evaluation unit 13 is implemented by, for example, a model evaluation circuit 26 illustrated in FIG. 2.

The model evaluation unit 13 acquires the learning model MDL′ after machine learning from the model learning unit 12.

The model evaluation unit 13 outputs the learning model MDL′ after machine learning to the model output unit 14.

The model evaluation unit 13 evaluates the performance of the learning model MDL′ after machine learning, and records the performance of the learning model MDL′ in the performance recording unit 4.

In addition, the model evaluation unit 13 records the feature quantity Fv extracted by the feature quantity extracting unit 7 in the feature quantity recording unit 3, and records the preprocessing P_{SEL} acquired by the preprocessing acquisition unit 11 in the preprocessing recording unit 5.

When acquiring the plurality of learning models MDL′ after machine learning from the model learning unit 12, the model evaluation unit 13 evaluates the performance of each of the plurality of learning models MDL′ after machine learning, and selects one or more learning models MDL′ from the plurality of learning models MDL′ after machine learning on the basis of the performance evaluation result.

The model evaluation unit 13 outputs the selected learning model MDL′ to the model output unit 14.

The model evaluation unit 13 records the performance of the selected learning model MDL′ in the performance recording unit 4.

In addition, the model evaluation unit 13 records the feature quantity Fv extracted by the feature quantity extracting unit 7 in the feature quantity recording unit 3, and records the preprocessing P_{SEL} acquired by the preprocessing acquisition unit 11 in the preprocessing recording unit 5.

The model output unit 14 is implemented by, for example, a model output circuit 27 illustrated in FIG. 2.

The model output unit 14 acquires the learning model MDL′ after machine learning from the model evaluation unit 13.

The model output unit 14 outputs the learning model MDL′ after machine learning to, for example, a device using the learning model MDL′.

In FIG. 1, it is assumed that each of the image set acquiring unit 1, the data storage unit 2, the image set selecting unit 6, the preprocessing selection unit 9, the model learning unit 12, the model evaluation unit 13, and the model output unit 14, which are components of the machine learning device, is implemented by dedicated hardware illustrated in FIG. 2. That is, it is assumed that the machine learning device is implemented by the image set acquiring circuit 21, the data storage circuit 22, the image set selecting circuit 23, the preprocessing selection circuit 24, the model learning circuit 25, the model evaluation circuit 26, and the model output circuit 27.

Here, the data storage circuit 22 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

In addition, each of the image set acquiring circuit 21, the image set selecting circuit 23, the preprocessing selection circuit 24, the model learning circuit 25, the model evaluation circuit 26, and the model output circuit 27 corresponds to, for example, a single circuit, a composite circuit, a programmed processor, a parallel-programmed processor, an application specific integrated circuit (ASIC), a field-programmable gate array (FPGA), or a combination thereof.

The components of the machine learning device are not limited to those implemented by dedicated hardware, and the machine learning device may be implemented by software, firmware, or a combination of software and firmware.

The software or firmware is stored in a memory of a computer as a program. The computer means hardware that executes the program, and corresponds to, for example, a central processing unit (CPU), a graphics processing unit (GPU), a central processing device, a processing device, an arithmetic device, a microprocessor, a microcomputer, a processor, or a digital signal processor (DSP).

FIG. 3 is a hardware configuration diagram of a computer in a case where the machine learning device is implemented by software, firmware, or the like.

In a case where the machine learning device is implemented by software, firmware, or the like, the data storage unit 2 is configured on a memory 31 of the computer. A machine learning program is stored in the memory 31, the machine learning program causing the computer to perform an image set acquiring procedure, an image set selecting procedure, a performance comparison procedure, a preprocessing acquisition procedure, a model learning procedure, a model evaluation procedure, and a model output procedure as the processing procedures performed in the image set acquiring unit 1, the image set selecting unit 6, the performance comparison unit 10, the preprocessing acquisition unit 11, the model learning unit 12, the model evaluation unit 13, and the model output unit 14, respectively. A processor 32 of the computer executes the machine learning program stored in the memory 31.

In addition, FIG. 2 illustrates an example in which each of the components of the machine learning device is implemented by dedicated hardware, and FIG. 3 illustrates an example in which the machine learning device is implemented by software, firmware, or the like. However, this is merely an example, and some components in the machine learning device may be implemented by dedicated hardware, and the remaining components may be implemented by software, firmware, or the like.

Next, an operation of the machine learning device illustrated in FIG. 1 will be described.

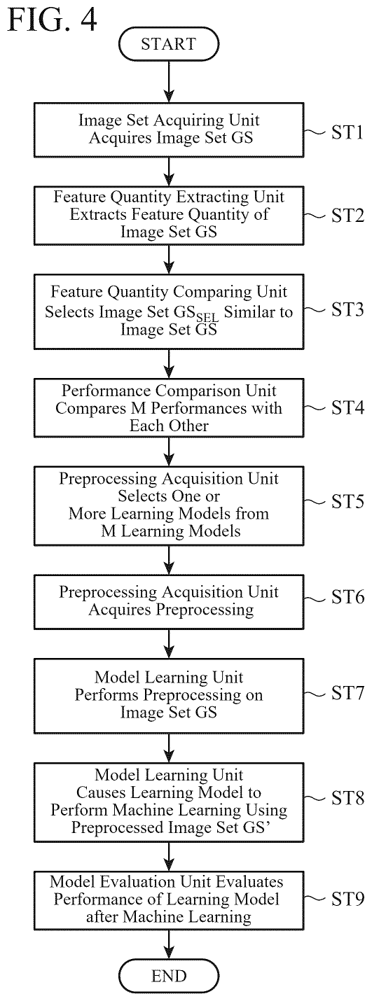

FIG. 4 is a flowchart illustrating a machine learning method that is a processing procedure performed by the machine learning device.

The image set acquiring unit 1 acquires an image set GS including one or more images from the outside (step ST1 in FIG. 4).

The method of acquiring the image set GS may be any method, for example, a method of reading the image set from an external storage device (not illustrated) or a method of reading the image set from a communication device (not illustrated) via a network may be used.

The image set acquiring unit 1 outputs the image set GS to each of the image set selecting unit 6 and the model learning unit 12.

The feature quantity extracting unit 7 of the image set selecting unit 6 acquires the image set GS from the image set acquiring unit 1.

The feature quantity extracting unit 7 extracts a feature quantity Fv of the image set GS (step ST2 in FIG. 4).

Examples of the feature quantity Fv extracted by the feature quantity extracting unit 7 include a feature quantity Fv in which the average value of pixel values of N images included in the image set GS, the variance value of pixel values of the N images, and the like are represented in the form of a multidimensional vector.

In addition, examples of the feature quantity Fv include a feature quantity Fv in which N images included in the image set GS are embedded in any vector space, and each image is represented by a set of vectors.

Moreover, examples of the feature quantity Fv include a feature quantity Fv in which N images included in the image set GS are embedded in any vector space, and the distribution of the image set GS in the vector space is represented.

The feature quantity extracting unit 7 outputs the feature quantity Fv of the image set GS to each of the feature quantity comparing unit 8 and the model evaluation unit 13.

The feature quantity comparing unit 8 acquires the feature quantity Fv of the image set GS from the feature quantity extracting unit 7.

The feature quantity comparing unit 8 acquires feature quantities Fv₁ to Fv_{N} extracted respectively from the N image sets GS₁ to GS_{N} from the feature quantity recording unit 3.

The feature quantity comparing unit 8 compares the feature quantity Fv of the image set GS with the feature quantity Fvₙ of the image set GSₙ (n=1, . . . , N), and determines how much the image set GS and the image set GSₙ are similar to each other on the basis of the comparison result between the feature quantity Fv and the feature quantity Fvₙ.

As a method of determining the similarity between the image set GS and the image sets GS₁ to GS_{N}, the feature quantity comparing unit 8 calculates, for example, a Euclidean distance between the feature quantity Fv and the feature quantities Fv₁ to Fv_{N}, a Mahalanobis distance between the feature quantity Fv and the feature quantities Fv₁ to Fv_{N}, or a Frechet inception distance between the feature quantity Fv and the feature quantities Fv₁ to Fv_{N}. The feature quantity comparing unit 8 can use a method of comparing N Euclidean distances, N Mahalanobis distances, or N Frechet inception distances, and performing determination on the basis of the comparison result of the Euclidean distances, the comparison result of the Mahalanobis distances, or the comparison result of the Frechet inception distances.

In addition, as a method of determining the similarity between the image set GS and the image sets GS₁ to GS_{N}, the feature quantity comparing unit 8 calculates, for example, a cosine similarity between the feature quantity Fv and the feature quantities Fv₁ to Fv_{N}, or Dice coefficients of the feature quantity Fv and the feature quantities Fv₁ to Fv_{N}. The feature quantity comparing unit 8 then can use a method of comparing N cosine similarities or N dice coefficients and performing determination on the basis of the comparison result of the cosine similarities or the comparison result of the dice coefficients.

The feature quantity comparing unit 8 selects an image set GS_{SEL} similar to the image set GS from the N image sets GS₁ to GS_{N} on the basis of the comparison result between the feature quantity Fv of the image set GS and the N feature quantities Fv₁ to Fv_{N} (step ST3 in FIG. 4).

Specifically, the feature quantity comparing unit 8 selects the image set GS_{SEL} most similar to the image set GS from the N image sets GS₁ to GS_{N} on the basis of the comparison result between the feature quantity Fv of the image set GS and the N feature quantities Fv₁ to Fv_{N}.

Here, the feature quantity comparing unit 8 selects the image set GS_{SEL} most similar to the image set GS from the N image sets GS₁ to GS_{N}. However, this is merely an example, and the feature quantity comparing unit 8 may select an image set GS_{SEL} with a similarity equal to or higher than a threshold from the N image sets GS₁ to GS_{N}. For example, when image sets with a similarity equal to or higher than the threshold are GS₂ and GS₅ among the N image sets GS₁ to GS_{N}, the image sets GS₂ and GS₅ are selected as the image set GS_{SEL}. The threshold may be stored in an internal memory of the feature quantity comparing unit 8 or may be provided from the outside of the machine learning device.

The feature quantity comparing unit 8 outputs the selected image set GS_{SEL} to the performance comparison unit 10.

The performance comparison unit 10 acquires the image set GS_{SEL} from the feature quantity comparing unit 8.

In addition, the performance comparison unit 10 acquires performances S_{SEL,1} to S_{SEL,M} of M machine-learned learning models MDL_{SEL,1} to MDL_{SEL,M} from the performance recording unit 4.

The machine-learned learning model MDL_{SEL,m} (m=1, . . . , M) is a learning model that has performed machine learning using an image set GS_{SEL,m} obtained by performing preprocessing Pₘ on the image set GS_{SEL} selected by the image set selecting unit 6.

Examples of the preprocessing Pₘ include missing value processing, outlier processing, resizing, and filtering. When the number of the preprocessing Pₘ is M, the performance recording unit 4 records M performances S_{SEL,1} to S_{SEL,M} as the performance S_{SEL,m} of the learning model MDL_{SEL,m} that has performed machine learning using the preprocessed image set obtained by performing the preprocessing Pₘ (m=1, . . . , M) on the image set GS_{SEL} selected by the image set selecting unit 6.

The performance comparison unit 10 compares the M performances S_{SEL,1} to S_{SEL,M} with each other (step ST4 in FIG. 4), and outputs the performance comparison result to the preprocessing acquisition unit 11.

The preprocessing acquisition unit 11 acquires the performance comparison result from the performance comparison unit 10.

The preprocessing acquisition unit 11 selects one or more learning models MDL_{SEL} from the M learning models MDL_{SEL,1} to MDL_{SEL,M} on the basis of the performance comparison result by the performance comparison unit 10 (step ST5 in FIG. 4).

Specifically, the preprocessing acquisition unit 11 may select, as the learning model MDL_{SEL}, for example, a learning model with the highest performance, may select several top learning models with high performance, or may select a learning model with a performance equal to or higher than a threshold from the M learning models MDL_{SEL,1} to MDL_{SEL,M}.

The preprocessing acquisition unit 11 acquires, as the preprocessing P_{SEL} suitable for the image set GS, preprocessing Pₘ performed on the image set GS_{SEL,m} used for machine learning of the learning model MDL_{SEL} from the M pieces of preprocessing P₁ to P_{M} recorded in the preprocessing recording unit 5 (step ST6 in FIG. 4).

The preprocessing acquisition unit 11 outputs the preprocessing P_{SEL} to each of the model learning unit 12 and the model evaluation unit 13.

The model learning unit 12 acquires the image set GS from the image set acquiring unit 1, and acquires the preprocessing P_{SEL} from the preprocessing acquisition unit 11.

The model learning unit 12 performs the preprocessing P_{SEL} on the image set GS (step ST7 in FIG. 4).

In a case where a plurality of pieces of preprocessing P_{SEL} are acquired by the preprocessing acquisition unit 11, the model learning unit 12 performs each piece of preprocessing P_{SEL} on the image set GS.

The model learning unit 12 causes the learning model MDL that has not yet trained to perform machine learning using the preprocessed image set GS' (step ST8 in FIG. 4). The unlearned learning model MDL may be stored in the internal memory of the model learning unit 12 or may be stored in a storage device or the like provided outside the model learning unit 12.

In a case where a plurality of pieces of preprocessing P_{SEL} are acquired by the preprocessing acquisition unit 11, the model learning unit 12 causes the learning model MDL that has not yet trained to perform machine learning using each preprocessed image set GS'

The model learning unit 12 outputs a plurality of learning models MDL′ after machine learning to the model evaluation unit 13.

When acquiring one learning model MDL′ after machine learning from the model learning unit 12, the model evaluation unit 13 evaluates the performance S of the one learning model MDL′ after machine learning (step ST9 in FIG. 4).

When acquiring a plurality of learning models MDL′ after machine learning from the model learning unit 12, the model evaluation unit 13 evaluates the performance S of each of the plurality of learning models MDL′ after machine learning (step ST9 in FIG. 4).

Examples of the evaluation method of the performance S include a method based on the magnitude of loss in machine learning of the learning model MDL′, a method based on the accuracy rate using an evaluation image set, and a method using an area under the curve (AUC) for the evaluation image set as an index.

When acquiring one learning model MDL′ after machine learning from the model learning unit 12, the model evaluation unit 13 outputs the one learning model MDL′ after machine learning to the model output unit 14.

When acquiring a plurality of learning models MDL′ after machine learning from the model learning unit 12, the model evaluation unit 13 outputs a learning model MDL′ whose performance S is evaluated as the highest among the plurality of learning models MDL′ after machine learning to the model output unit 14.

Here, the model evaluation unit 13 outputs the learning model MDL′ whose performance S is evaluated as the highest among the plurality of learning models MDL′ after machine learning to the model output unit 14. However, this is merely an example, and the model evaluation unit 13 may output several top learning models MDL′ whose performance S is highly evaluated among the plurality of learning models MDL′ after machine learning to the model output unit 14.

In addition, the model evaluation unit 13 may output the learning model MDL′ whose performance S is evaluated higher than or equal to a threshold among the plurality of learning models MDL′ after machine learning to the model output unit 14.

The model evaluation unit 13 records the performance S of the learning model MDL′ output to the model output unit 14 in the performance recording unit 4.

In addition, the model evaluation unit 13 records the feature quantity Fv extracted by the feature quantity extracting unit 7 in the feature quantity recording unit 3, and records the preprocessing P_{SEL} acquired by the preprocessing acquisition unit 11 in the preprocessing recording unit 5.

The model output unit 14 acquires the learning model MDL′ after machine learning from the model evaluation unit 13.

The model output unit 14 outputs the learning model MDL′ after machine learning to, for example, a device using the learning model MDL′.

In the first embodiment, the machine learning device is configured to include the image set acquiring unit 1 to acquire an image set including one or more images, and the image set selecting unit 6 to select an image set similar to an image set acquired by the image set acquiring unit 1 from a plurality of image sets different from the image set acquired by the image set acquiring unit 1. In addition, the machine learning device includes the performance comparison unit 10 to acquire, as performances of a plurality of machine-learned learning models, a performance of a learning model that has performed machine learning using each of preprocessed image sets obtained by performing a plurality of pieces of different preprocessing on the image set selected by the image set selecting unit 6, and to compare the performances of the plurality of machine-learned learning models with each other, and the preprocessing acquisition unit 11 to select a learning model from the plurality of machine-learned learning models based on a performance comparison result by the performance comparison unit 10 and to acquire preprocessing performed on an image set used for machine learning of the learning model selected. Furthermore, the machine learning device includes the model learning unit 12 to perform preprocessing acquired by the preprocessing acquisition unit 11 on the image set acquired by the image set acquiring unit 1 and to cause a learning model that has not yet trained to perform machine learning using the preprocessed image set. Therefore, even when one or more images included in the image set include a missing value or the like, the machine learning device can suppress a decrease in performance of the learning model after machine learning.

In the machine learning device illustrated in FIG. 1, the model learning unit 12 causes the learning model MDL that has not yet trained to perform machine learning using the image set GS' obtained through the preprocessing selected by the preprocessing selection unit 9. However, this is merely an example, and the model learning unit 12 may cause the learning model MDL that has not yet trained to perform machine learning using the image set GS without performing preprocessing on the image set GS acquired by the image set acquiring unit 1, in addition to causing the learning model MDL that has not yet trained to perform machine learning using the image set GS' obtained through the preprocessing selected by the preprocessing selection unit 9.

In this case, the model evaluation unit 13 evaluates the performance S of the learning model MDL′ after machine learning using the image set GS' obtained through the preprocessing selected by the preprocessing selection unit 9, and evaluates the performance S of the learning model MDL′ after machine learning using the image set GS acquired by the image set acquiring unit 1. The model evaluation unit 13 then selects one or more learning models MDL′ from the learning models MDL′ after machine learning on the basis of the evaluation result of the performances S of the learning models MDL′ after machine learning.

### Second Embodiment

In a second embodiment, a machine learning device including a data dimension reducing unit 15 that reduces the data dimension of the image set GS acquired by the image set acquiring unit 1 will be described.

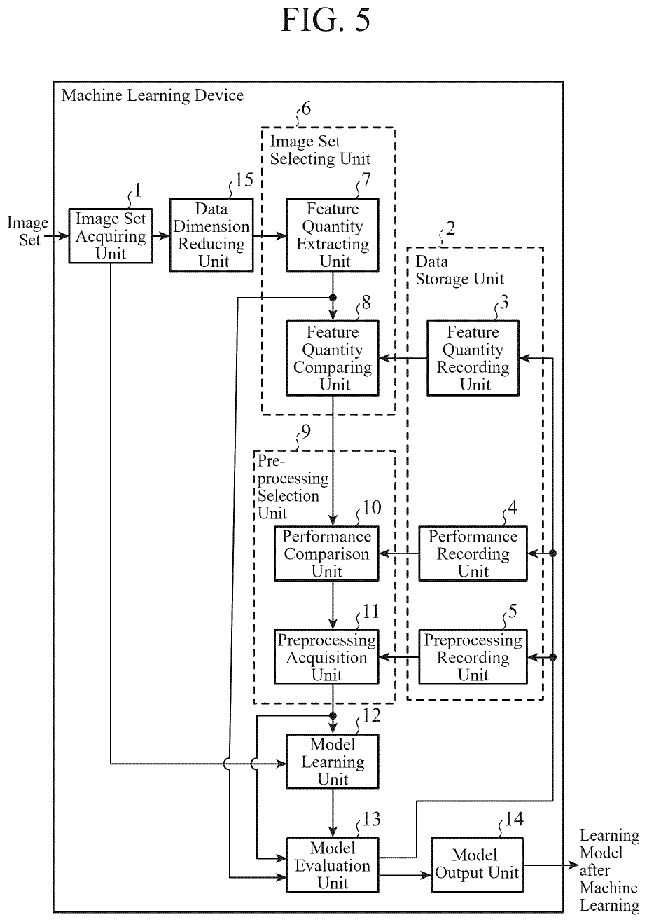

FIG. 5 is a configuration diagram illustrating a machine learning device according to the second embodiment. In FIG. 5, the same reference numerals as those in FIG. 1 denote the same or corresponding parts, and thus description thereof is omitted.

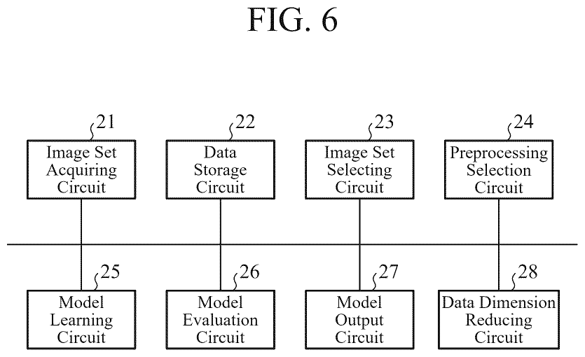

FIG. 6 is a hardware configuration diagram illustrating hardware of the machine learning device according to the second embodiment. In FIG. 6, the same reference numerals as those in FIG. 2 denote the same or corresponding parts, and thus description thereof is omitted.

The machine learning device illustrated in FIG. 5 includes the image set acquiring unit 1, the data dimension reducing unit 15, the data storage unit 2, the image set selecting unit 6, the preprocessing selection unit 9, the model learning unit 12, the model evaluation unit 13, and the model output unit 14.

The data dimension reducing unit 15 is implemented by, for example, a data dimension reducing circuit 28 illustrated in FIG. 6.

The data dimension reducing unit 15 acquires the image set GS from the image set acquiring unit 1.

The data dimension reducing unit 15 reduces the data dimension of the image set GS.

The data dimension reducing unit 15 outputs an image set GS″ after data dimension reduction to a feature quantity extracting unit 7a of the image set selecting unit 6.

In the machine learning device illustrated in FIG. 5, the image set selecting unit 6 includes the feature quantity extracting unit 7a and the feature quantity comparing unit 8.

The feature quantity extracting unit 7a acquires the image set GS″ after data dimension reduction from the data dimension reducing unit 15.

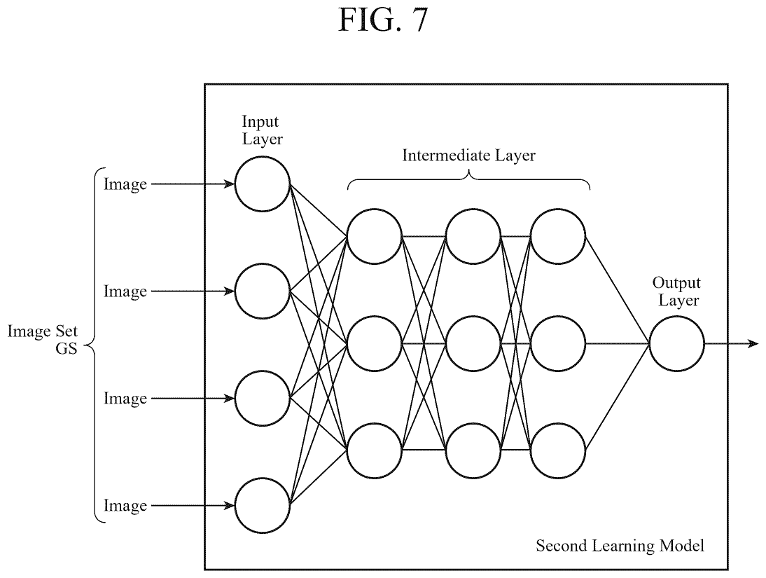

The feature quantity extracting unit 7a provides the image set GS″ after data dimension reduction to, for example, a second learning model illustrated in FIG. 7.

The feature quantity extracting unit 7a acquires a vector set output from either an intermediate layer of the second learning model or an output layer of the second learning model as the feature quantity Fv to be extracted.

The feature quantity extracting unit 7a outputs the feature quantity Fv to the feature quantity comparing unit 8.

FIG. 7 is an explanatory diagram illustrating an example of the second learning model to which the image set GS″ after data dimension reduction is provided.

The second learning model is, for example, a learning model that has received the image set after data dimension reduction and teaching data indicating the feature quantity of the image set at the time of learning, and has machine-learned the feature quantity of the image set. When the image set GS″ after data dimension reduction is provided to the input layer at the time of inference, the second learning model outputs the feature quantity Fv of the image set GS″ from the intermediate layer or the output layer.

In FIG. 5, it is assumed that each of the image set acquiring unit 1, the data dimension reducing unit 15, the data storage unit 2, the image set selecting unit 6, the preprocessing selection unit 9, the model learning unit 12, the model evaluation unit 13, and the model output unit 14, which are components of the machine learning device, is implemented by dedicated hardware illustrated in FIG. 6. That is, it is assumed that the machine learning device is implemented by the image set acquiring circuit 21, the data dimension reducing circuit 28, the data storage circuit 22, the image set selecting circuit 23, the preprocessing selection circuit 24, the model learning circuit 25, the model evaluation circuit 26, and the model output circuit 27.

Each of the image set acquiring circuit 21, the data dimension reducing circuit 28, the image set selecting circuit 23, the preprocessing selection circuit 24, the model learning circuit 25, the model evaluation circuit 26, and the model output circuit 27 corresponds to, for example, a single circuit, a composite circuit, a programmed processor, a parallel-programmed processor, ASIC, FPGA, or a combination thereof.

The components of the machine learning device are not limited to those implemented by dedicated hardware, and the machine learning device may be implemented by software, firmware, or a combination of software and firmware.

In a case where the machine learning device is implemented by software, firmware, or the like, the data storage unit 2 is configured on the memory 31 illustrated in FIG. 3. A machine learning program is stored in the memory 31 illustrated in FIG. 3, the machine learning program causing a computer to perform an image set acquiring procedure, a data dimension reducing procedure, an image set selecting procedure, a performance comparison procedure, a preprocessing acquisition procedure, a model learning procedure, a model evaluation procedure, and a model output procedure as the processing procedures performed in the image set acquiring unit 1, the data dimension reducing unit 15, the image set selecting unit 6, the performance comparison unit 10, the preprocessing acquisition unit 11, the model learning unit 12, the model evaluation unit 13, and the model output unit 14, respectively. Then, the processor 32 illustrated in FIG. 3 executes the machine learning program stored in the memory 31.

In addition, FIG. 6 illustrates an example in which each of the components of the machine learning device is implemented by dedicated hardware, and FIG. 3 illustrates an example in which the machine learning device is implemented by software, firmware, or the like. However, this is merely an example, and some components in the machine learning device may be implemented by dedicated hardware, and the remaining components may be implemented by software, firmware, or the like.

Next, an operation of the machine learning device illustrated in FIG. 5 will be described.

Here, the machine learning device is similar to the machine learning device illustrated in FIG. 1 except for the data dimension reducing unit 15 and the feature quantity extracting unit 7a. For this reason, only the operations of the data dimension reducing unit 15 and the feature quantity extracting unit 7a will be described here.

The data dimension reducing unit 15 acquires the image set GS from the image set acquiring unit 1.

The data dimension reducing unit 15 reduces the data dimension of the image set GS.

Examples of a method of reducing the data dimension include a method in which the image set GS is provided to an input layer of a convolutional neural network (hereinafter, referred to as “CNN”) learned by an image set for an ImageNet classification task, and a vector set output from either an intermediate layer of the CNN or an output layer of the CNN is output as the image set GS″ after data dimension reduction.

In the machine learning device illustrated in FIG. 5, it is assumed that the image set GS″ after data dimension reduction by the data dimension reducing unit 15 is an image set whose data size is reduced by any method.

The data dimension reducing unit 15 outputs an image set GS″ after data dimension reduction to a feature quantity extracting unit 7a of the image set selecting unit 6.

The feature quantity extracting unit 7a acquires the image set GS″ after data dimension reduction from the data dimension reducing unit 15.

The feature quantity extracting unit 7a provides each image included in the image set GS″ after data dimension reduction to, for example, any input layer in the second learning model illustrated in FIG. 7.

The feature quantity extracting unit 7a acquires a vector set output from either the intermediate layer of the second learning model or the output layer of the second learning model as the feature quantity Fv to be extracted.

In the example of FIG. 7, the second learning model includes the intermediate layer with a three-stage configuration. However, this is merely an example, and the second learning model may include the intermediate layer with two stages or less or the intermediate layer with four stages or more.

For example, in a case where the second learning model includes the intermediate layer with a three-stage configuration, a vector set output from the intermediate layer of any stage among the three-stage intermediate layers is acquired as the feature quantity Fv to be extracted.

The feature quantity extracting unit 7a may calculate the probability mass function of the vector set output from either the intermediate layer of the second learning model or the output layer of the second learning model, and define the probability mass function as the feature quantity Fv.

In the second embodiment, the machine learning device illustrated in FIG. 5 is configured to include the data dimension reducing unit 15 that reduces the data dimension of the image set acquired by the image set acquiring unit 1. Therefore, similarly to the machine learning device illustrated in FIG. 1, the machine learning device illustrated in FIG. 5 can suppress a decrease in performance of a learning model after machine learning even when one or more images included in an image set include a missing value or the like, and can also reduce unnecessary information. As a result, the machine learning device illustrated in FIG. 5 can improve the calculation accuracy of the feature quantity and can speed up the comparison processing of the feature quantity as compared with the machine learning device illustrated in FIG. 1.

In the machine learning device illustrated in FIG. 5, the feature quantity extracting unit 7a acquires the feature quantity Fv to be extracted by providing the image set GS″ after data dimension reduction to the input layer of the second learning model. However, this is merely an example, and the feature quantity extracting unit 7a may extract the feature quantity Fv of the image set GS″ similarly to the feature quantity extracting unit 7 illustrated in FIG. 1.

In the machine learning device illustrated in FIG. 5, the feature quantity extracting unit 7a acquires the feature quantity Fv to be extracted by providing the image set GS″ after data dimension reduction to the input layer of the second learning model. However, this is merely an example, and the feature quantity extracting unit 7a may provide the image set GS acquired by the image set acquiring unit 1 to the input layer of the second learning model and acquire, as the feature quantity Fv to be extracted, a vector set output from either the intermediate layer of the second learning model or the output layer of the second learning model.

In this case, the second learning model is, for example, a learning model that has received the image set and teaching data indicating the feature quantity of the image set at the time of learning and has machine-learned the feature quantity of the image set. When the image set GS″ is provided to the input layer at the time of inference, the second learning model outputs the feature quantity Fv of the image set GS from the intermediate layer or the output layer.

Note that it is possible to freely combine the embodiments, modify any component of each embodiment, or omit any component of each embodiment in the present disclosure.

### INDUSTRIAL APPLICABILITY

The present disclosure is suitable for a machine learning device, a machine learning method, and a machine learning program.

### REFERENCE SIGNS LIST

1: image set acquiring unit, 2: data storage unit, 3: feature quantity recording unit, 4: performance recording unit, 5: preprocessing recording unit, 6: image set selecting unit, 7: feature quantity extracting unit, 7a: feature quantity extracting unit, 8: feature quantity comparing unit, 9: preprocessing selection unit, 10: performance comparison unit, 11: preprocessing acquisition unit, 12: model learning unit, 13: model evaluation unit, 14: model output unit, 15: data dimension reducing unit, 21: image set acquiring circuit, 22: data storage circuit, 23: image set selecting circuit, 24: preprocessing selection circuit, 25: model learning circuit, 26: model evaluation circuit, 27: model output circuit, 28: data dimension reducing circuit, 31: memory, 32: processor

1. A machine learning device comprising:
processing circuitry
to acquire an image set including one or more images;
to select an image set similar to the acquired image set from a plurality of image sets different from the acquired image set;
to acquire, as performances of a plurality of machine-learned learning models, a performance of a learning model that has performed machine learning using each of preprocessed image sets obtained by performing a plurality of pieces of different preprocessing on the selected image set, and to compare the performances of the plurality of machine-learned learning models with each other;
to select a learning model from the plurality of machine-learned learning models based on a performance comparison result and to acquire preprocessing performed on an image set used for machine learning of the learning model selected; and
to perform the acquired preprocessing on the acquired image set and to cause a learning model that has not yet trained to perform machine learning using the preprocessed image set.

2. The machine learning device according to claim 1, wherein the processing circuitry includes:
to extract a feature quantity of the acquired image set, and
to compare a feature quantity extracted from each of a plurality of image sets different from the acquired image set with the extracted feature quantity, and to select an image set similar to the acquired image set from the plurality of image sets based on a comparison result of the feature quantity.

3. The machine learning device according to claim 1, wherein
the processing circuitry has acquired a plurality of pieces of preprocessing,
the processing circuitry has performed each piece of the acquired preprocessing on the acquired image set, and a learning model that has not yet trained has performed machine learning using each of preprocessed image sets, and the processing circuitry being further configured
to evaluate a performance of each of a plurality of learning models after machine learning, and to select one or more learning models from the plurality of learning models after machine learning based on an evaluation result of the performance.

4. The machine learning device according to claim 3, wherein
the processing circuitry
causes a learning model that has not yet trained to perform machine learning using an image set without performing preprocessing on the acquired image set, in addition to causing the learning model that has not yet trained to perform machine learning using each of preprocessed image sets, and
the processing circuitry
evaluates a performance of each of a plurality of learning models after machine learning, and selects one or more learning models from the plurality of learning models after machine learning based on an evaluation result of the performance.

5. The machine learning device according to claim 1, wherein the processing circuitry is further configured to reduce a data dimension of the acquired image set and output an image set after data dimension reduction.

6. The machine learning device according to claim 2, wherein the processing circuitry
provides the acquired image set to a second learning model, and acquires, as a feature quantity to be extracted, a vector set output from either an intermediate layer of the second learning model or an output layer of the second learning model.

7. The machine learning device according to claim 2, wherein the processing circuitry is further configured to reduce a data dimension of the acquired image set,
wherein the processing circuitry
provides an image set after data dimension reduction to a second learning model, and acquires, as a feature quantity to be extracted, a vector set output from either an intermediate layer of the second learning model or an output layer of the second learning model.

8. The machine learning device according to claim 2, wherein the processing circuitry
calculates a Frechet inception distance between a feature quantity extracted from each of a plurality of image sets different from the acquired image set and the extracted feature quantity, compares a plurality of Frechet inception distances with each other, and selects an image set similar to the acquired image set from the plurality of image sets based on a comparison result of the Frechet inception distance.

9. A machine learning method comprising:
acquiring an image set including one or more images;
selecting an image set similar to the acquired image set from a plurality of image sets different from the acquired image set;
acquiring, as performances of a plurality of machine-learned learning models, a performance of a learning model that has performed machine learning using each of preprocessed image sets obtained by performing a plurality of pieces of different preprocessing on the selected image set, and comparing the performances of the plurality of machine-learned learning models with each other;
selecting a learning model from the plurality of machine-learned learning models based on a performance comparison result and acquiring preprocessing performed on an image set used for machine learning of the learning model selected; and
performing the acquired preprocessing on the acquired image set and causing a learning model that has not yet trained to perform machine learning using the preprocessed image set.

10. A non-transitory computer-readable medium comprising a machine learning program to cause a computer to execute:
acquiring an image set including one or more images;
selecting an image set similar to the acquired image set from a plurality of image sets different from the acquired image set;
acquiring, as performances of a plurality of machine-learned learning models, a performance of a learning model that has performed machine learning using each of preprocessed image sets obtained by performing a plurality of pieces of different preprocessing on the selected image set, and comparing the performances of the plurality of machine-learned learning models with each other,
selecting a learning model from the plurality of machine-learned learning models based on a performance comparison result and acquiring preprocessing performed on an image set used for machine learning of the learning model selected; and
performing the acquired preprocessing on the acquired image set and causing a learning model that has not yet trained to perform machine learning using the preprocessed image set.
